(19) United States
(12) Patent Application Publication
(10) Pub. No.: US 2018/0067069 A1
(43) Pub. Date: Mar. 8, 2018

(54) Integrated threaded compacting electrical contact (ITCEC)

(71) Applicant: David P. Newman, Fort Morgan, CO (US)

(72) Inventor: David P. Newman, Fort Morgan, CO (US)

(21) Appl. No.: 15/330,306

(22) Filed: Sep. 2, 2016

(51) Int. Cl. G01N 27/30

(52) U.S. Cl. CPC G01N 27/308

(57) ABSTRACT

The present invention pertains to manufactured electrochemical sensing electrodes in which the sensing element is a composite of sensing powder and a bonding medium, such as powder graphite and epoxy, in which desired physical properties and electrical properties are all obtained essentially simultaneously. After initially and partially compacting the sensing powder to obtain interfacial contact between particles, it is infused with a bonding medium. The bonding medium fills interstitial spaces remaining between powder particles by capillary action. A contact screw then serves to complete compaction of this sensing powder composite, during which the previously established interfacial contact prevents electrical interference between particles by the insular bonding medium. Simultaneously electrical contact by the contact screw is established by penetration of and displacement of some sensing composite material along the threaded surface of the penetrating screw tip, maximizing contact area. Cure of the bonding medium results in an rugged integrated sensor conductor structure in which conductivity between particles and between composite and conductor is optimal, thereby delivering optimal electrochemical performance.

### CROSS REFERENCE TO RELATED APPLICATIONS

This application relates to Provisional Patent Application No. 62/284,275, Sep. 24, 2015, Confirmation No. 8729.

### BACKGROUND OF THE INVENTION

This invention relates to the manufacture of sensing electrode devices such as employed in electrochemistry, in particular to electrode devices in which the sensing element is formed from powder materials such as powder graphite or powder metal. In addition it relates to integrating the electrical connection with the physical formation of the sensing element.

Although there is a considerable variety of such products in the market, an electrode of the type this invention pertains to typically has an initially hollow plastic cylindrical body with a sensing element exposed at one end and an electrical lead extending from the opposite end. The interior end of the electrical lead is connected to the interior surface of the sensing element. Once this arrangement of components is assembled, the cylinder is filled with resin, such as epoxy resin, to create a protected and durable structure.

In use, the exposed sensing element surface end of the electrode is placed in contact with a substance of interest, for example in a beaker containing water with a sample of such a substance. The extended lead at the other end of the electrode assembly is connected to appropriate instrumentation enabling a signal from the interaction of the sensing element with the substance to be detected and recorded. In use there will be at least one other electrode also in the beaker to enable creation of a detection circuit, and there are numerous variations of this basic design available in the market.

The formation of a sensing element from powder is accomplished in several ways. A sensing powder is chosen that has known or probable reactivity to a substance of interest. One common technique is to place a quantity of this powder mixed with a bonding resin such as epoxy into a closed ended cylinder and then insert a close fitting flat ended pin. This pin is pushed further into the cylinder until it contacts the powder and resin composite mix, and then considerable force is applied to press the pin acting as a piston against the composite compacting it into a dense disk shape which becomes the sensing element of the electrode as the resin cures into a solid. Filanovsky et al, U.S. Pat. No. 6,015,522 discloses technology of this nature. If this pin also happens to be of suitable material, for example brass, it can be bonded into place to become the electrical lead of the electrode. Alternatively, after compaction, the compacting pin can be removed, a conductive cement applied to the interior side of the compacted mix, and a wire inserted into this cement which is then allowed to cure. Back filling the cylinder with a potting resin creates an essentially solid structure and completes the assembly Cutting or grinding away excess cylinder material at the closed end of the cylinder exposes the composite sensing element outer surface ready for final finishing or polishing, and then use.

There are challenges associated with composite constructions of this nature. A primary one is establishing the optimal ratio of sensing powder to bonding resin. For example, the detailed analyses of Filanovsky et al, U.S. Pat. No. 6,015,522 describe a preferred structure in which almost ten percent of the sensor mass is non-reactive binder material. The bonding resin is necessarily nonconductive or it would be an electrically active ingredient in conflict with the electrical properties of the sensing powder. It therefore can be appreciated that too much non-conducting resin in the composite mix will interfere with the electrical properties of the sensing element powder, while too little will compromise the structural strength of the composite.

A detailed analysis of even the most optimal ratio reveals a further problem. When the mix is formed, a fully homogeneous blend of powder and resin results in all powder particles being coated with the non-conducting resin. For suitable electrical conductivity to then be established in the compacted composite sensing element, very high pressure must be applied to displace this coating, which is in contact with the powder particles in a molecularly intimate relation, in order to push the particles into electrical contact with each other. In practical terms, it is very difficult if not impossible to completely eliminate the electrical interference caused by this particle coating phenomenon. Sensing elements made this way can have through resistance that is undesirably high, directly diminishing electrode sensing performance. Even when minimized, any such interference with conduction results in less than optimal electrical performance.

A closely related potential problem is in regard to the contact between the electrical lead and the compacted sensing element. The nonconductive bonding resin must be displaced sufficiently here as well to allow direct contact between the lead and the sensing element's compacted powder. The available interacting surface area is defined by the diameter of the sensing element which in turn is defined by the internal diameter of the cylinder, and this can be an important limitation to establishing sufficient parallel conductive paths in the situation in which the bonding resin is a partial interference to electrical conductivity.

Electrical contact between two components in general is one of the most frequently encountered requirements in industry. Nearly all electrical devices require one or more such contacts. FIG. 1 of Hanspeter et al, U.S. Pat. No. 4,057,480 is illustrative of one class of such contacts. Although the invention pertains to other characteristics, this figure depicts one of the simplest approaches to electrical contact, a simple butt joint between a power carrying lead and an anode. As depicted here, there is no evident connection security. In general, simple butt joints have proven to be minimally secure. Filanovsky et al, U.S. Pat. No. 6,015,522 discussed earlier discloses related technology in which compacting and contacting force is achieved at room temperature with the aid of a screw. The invention achieves a secure butt joint but at the cost of considerable complexity. Such constructions necessarily rely on the compressing surface area of the pin which defines the limit to reduction in device resistance. Secrist et al, U.S. Pat. No. 4,495,049 discloses an electrical contact method in which a current conductor is brazed to a cermet electrode with progressively variable metal content. This approach assures contact security but requires a significant investment in time and energy, also including sophisticated electrode material arrangements. It is only suited to components that can withstand high brazing temperatures and is therefore unsuited to the polymeric materials customarily used in electrodes for electrochemistry.

Embedding or encapsulating is another approach to achieving low resistance electrical contact. Ray et al, U.S. Pat. No. 7,122,270 discloses a current collector embedded in the anode material of a battery. Lafitte et al, U.S. Pat. No. 9,377,434 describes a connecting wire extending from a cavity packed with electrochemically active paste. A wire contact of this nature has minimal area exposed to the sensing element and is especially problematic when the sensing material itself has even a small bulk resistance. Kelsch et al, U.S. Pat. No. 6,592,730 discloses a form of encapsulating in which a glassy carbon electrode rod is tightly captured in the closed-end bore at the end of a conductive rod. Additional electrical contact security is provided by including a conductive spring between the end of the rod and seat of the cavity. There is the necessity of creating a precise bore to accommodate the glassy carbon rod in order to achieve the best electrical contact possible, and matching the diameter of the glassy rod to this bore requires additional precision. Enhancing conduction with the incorporated spring is necessarily limited by the minimal contact area of its end coils.

Finally, and more closely related to the present invention, threaded electrical connections are more complex, and there is a wide variety of these devices. Henderson, U.S. Pat. No. 2,790,962 discloses a captured lead making electrical contact against threads in a terminal assembly. This is a straight forward radial compression of the electrical lead against the threads of the Stud by Terminal Member which may also include a radially compressing spring. Actual contact area is very small as the conductor is pressed against thread edges. Delalle, U.S. Pat. No. 5,461,198 discloses an advancement in this kind of technology by the provision of solder incorporated into the threaded engagement. Subsequent to completing the threaded engagement, the device can be heated to melt the solder forming a nearly ideal electrical connection. While a successful solution to the problem of threaded electrical contact, this technology requires a complicated assembly and process, in addition to the application of high temperature to melt the solder. In a different industry a related solution to the problem of threaded component conductivity is addressed with H. V. Johnson et al, U.S. Pat. No. 3,048,434. In this invention, both thermal and electrical conductivity of a threaded carbon joint are enhanced by the provision of a meltable metal slug into the assembly. Upon reaching operating temperature, the molten metal creates the desired low resistance path between threaded electrode butt sockets and the connecting threaded nipple. The additional component complexity required by this invention is a relatively minor obstacle for the application intended. However, for electrochemistry sensors, the thermal requirement alone makes it technically impractical. Other work by Secrist et al, U.S. Pat. No. 4,443,314 addresses issues of threaded electrical contact to cermet electrodes. This patent discloses addressing the issues of connecting to a cermet electrode by the provision of a ceramic or cermet connector, avoiding the challenges to metal connectors at high temperatures and corrosive environments, though inappropriate for non-ceramic unsintered electrochemical electrodes. Also discussed is coating the threads of the conductor with a high temperature metal or providing a metal to be melted in the threaded cavity, both of which add complexity and cost. Secrist et al, U.S. Pat. No. 4,626,333 discloses the advancement of preparing an assembly of electrode and connector prior to the final sintering stage such that a low resistance joint is formed by sintering the components together as a pre-assembled unit. For conventional electrochemistry, making conductive leads and sensors with essentially the same material is generally not feasible for existing instrumentation that expects a lead wire to connect to, and the very high sintering temperatures required are prohibitive for such electrodes. Also considered is the application of platinum to the threads for the conductive advantage of this metal as well as for its high temperature tolerance, but which is an added expense.

### SUMMARY OF THE INVENTION

The present invention addresses these issues by compacting a sensing powder into the composite configuration of a sensing element in a three step compacting process while simultaneously providing secure integrated electrical contact: 1) A sensing powder is initially but not fully consolidated into the bottom of a closed end threaded cylinder. This initial consolidation of the sensing powder can be accomplished with modest force by a simple pin taking advantage of the characteristic of powder materials by which they resist flow laterally while experiencing compression axially. 2) A bonding epoxy resin is added and infuses by capillary action into this initially consolidated powder mass. 3) Final operational compacted density and integral electrical contact are simultaneously established by driving a compacting contact screw onto and into the initially consolidated and infused composite sensing powder mass, prior to curing the bonding resin.

The challenge of achieving an optimal ratio of sensing powder to bonding resin is thereby eliminated. By initially consolidating the sensing powder prior to infusing the bonding resin, inter-particulate contact is established without the possibility of interference by the bonding resin. This initial consolidation is sufficient to establish particle contact without completely eliminating interstitial spaces among the powder particles. Subsequently infused bonding resin finds its way throughout the mass by capillary action into these tiny spaces among the powder particles of the initially consolidated powder, and therefore the composite in effect determines its own inherently optimum powder-to-resin ratio.

With powder particle contact established without pre-existing resin barriers between particles, and interstitial infusion complete, final compaction with the compacting contact screw to final operational density with low resistance through the sensing element is readily achieved. As expected the harder the particles of a given size, the greater the compacting force required to achieve the same operational density, highlighting the advantage of the torque amplification advantage of the threaded compacting screw, which in this invention also penetrates the initially consolidated sensor material. As the compacting screw is driven onto and into the sensor material, bonding resin is displaced as particles are distorted and interfacial particle contact is extended. The unique phenomenon to be considered here is that, as particle interfacial contact area increases with increasing particle consolidation under increasing compression, resin remains excluded from entrance between the faces in intimate contact, and conductivity increases without resin interference.

Achieving this operational density of the sensing element in simultaneous conjunction with establishing electrical conductivity with the lead is dependent upon the fit between the threaded cylinder and the threaded compacting contact screw, so that the dimensions of these components are chosen carefully. What is desired is that the piston action of the turning screw be balanced with its ability to penetrate into the infused powder sensor mass, with penetration requiring that the compacting contact screw be able to displace some sensor material. The nature of the chosen thread engagement between the cylinder and screw from among the great variety of threaded component and tool specifications available makes this easy to accomplish without resorting to custom thread fabrication.

Just as flow along the sides of closely fitted piston surface in a cylinder will decrease as the length of this engagement increases, so does an increasing length of thread engagement raise resistance to flow along its spiral length. The spiral circumferential length of a threaded engagement can be very long in comparison to its axial length, and the finer the thread pitch, the greater this ratio. In practice, this allows for the diameter of the compacting tip of a compacting contact screw of this invention to be slightly smaller than the diameter of the threaded cylinder in which it operates. This enables its tip to penetrate the composite mass at the closed end of the threaded cylinder as it displaces some material into the gap between the inside threads of the cylinder and outside threads of the screw. With the comparatively large effective length of piston to cylinder engagement presented by the spiral nature of threaded assembly, this displaced flow is limited, and pressure builds in the confined volume of the sensing element. Elevated pressure on the penetrating screw tip as it enters the composite mass causes a scrubbing action to occur along its threads to develop intimate electrical contact between the screw and compacting composite particles. The result is a compacted sensing element accompanied by displaced sensing element material encompassing the tip of the penetrating compacting contact screw such that this tip is essentially encased in the compacted but thereby extended sensing element itself. Once cure of the bonding resin is complete the components are for all practical purposes a single solid integrated unit with excellent electrical properties.

For example a 5-40 brass compacting contact screw that penetrates such that 0.100 inch of its tip is encased in a composite sensing element mass at the bottom of a 5-40 threaded cylinder will have nearly fifty percent more contact area integrated into the composite] than will a straight-sided pin with equivalent fit and penetration. This is a major advantage in achieving low electrical resistance of the completed electrode.

The torque advantage of the screw geometry makes it easy with this construction to compact the sensing powder to maximum desired density while simultaneously affecting the desired penetration with modest applied turning effort. In practicing the preferred embodiment, a torque driver is used to apply a specific torque to the contact screw, and thereby repeatable electrode properties are established. This torque can be chosen according to the specific sensing powder selected.

The practical advantages of the present invention are apparent by comparison of test results. FIG. 2 of Filanovsky et al, U.S. Pat. No. 6,015,522 presents a useful display of typical voltammograms. A key determination of electrode performance is called “peak separation.” This is determined by scanning voltage applied to an electrode over a range and back, and then subtracting the voltage value at which the displayed curve reaches a peak scanning in one direction from the voltage value at which it reaches a peak scanning in the other direction. In this FIG. 2 of U.S. Pat. No. 6,015,222 which compares performance of the electrode of that invention to the performance of a glassy carbon electrode in an identical test, one peak of both can be seen to be at approximately 0.15V and the other at approximately 0.275. In this instance, subtraction of 0.15 from 0.275 delivers peak separation of 0.125V. Since glassy carbon electrodes are very commonly used in electrochemistry, the comparison is meaningful to electrochemists in demonstrating the probable utility of this invention. While theoretical peak separation is 0.058V, that value is rarely achieved in practical systems. This value of 0.125V separation is respectable. A separation of 0.100V is considered quite good and lower values very good. (Filanovsky does not specify the scan rate he used, and perhaps it was a high rate. If so, a lower rate would likely have yielded a smaller separation value. However, the point of this comparison is that the Filanovsky invention performs as well as glassy carbon, but glassy carbon is notorious for having variable and less than optimal performance in many situations.)

An examination of performance of the preferred embodiment of the present invention demonstrates its advantages. FIG. 7 and FIG. 8 present two views of a single voltammogram achieved in a test similar to the test. described in Filanovsky. This voltammogram was run in a neutral buffer with 3 mM ferro-ferricyanide, scanning 20 mV/second from minus 0.1V to plus 0.5V and back. Each figure includes voltammogram values from the data logger (WinDaq Waveform Browser, DATAQ Instruments, DI-155 Data Logger, ported to a PC.) FIG. 7 shows selection of the positive scan peak at 0.2490V. FIG. 8 shows selection of the negative scan peak of the same voltammogram at 0.0.1788V. Subtraction yields peak separation of 0.0702V, an excellent result, and one that is dependably delivered.

In the manufacturing of sensing electrodes that employ powder materials for the sensing element there is need for a construction method and design enabling excellent electrochemical performance with low electrical resistance, both through the sensing element itself and between the sensing element and electrical lead. There is need for manufacturing of such devices for which manufacturing is both easy and economical without requiring components that are expensive or assembly processes that are complex.

While the method and form of the invention herein described constitutes a preferred embodiment, it is to be understood that the invention is not limited to this precise method and form, and that changes may be made therein without departing from the scope of the invention which is defined in the appended claims. For example it is possible to use a thermoplastic resin for the bonding medium. In this case, with proper materials chosen, infusion would take place at elevated temperature and solidification of the composite resulting upon return to ambient. The electrode of the present invention may be incorporated as a sub-assembly into other components to make different sized or shaped final electrodes.

### BRIEF DESCRIPTION OF THE DRAWINGS

FIG. 1 is a cross section of the hollow threaded cylinder of the preferred embodiment of the present invention depicting sensing powder in place.

FIG. 2 is a conceptual depiction of initially consolidated powder by a pin.

FIG. 3 is a conceptual enlargement of initially consolidated powder infused with a resin.

FIG. 4 is a cross section of the present invention showing the stage in manufacturing in which the infused sensing powder is penetrated and compacted.

FIG. 5 is a conceptual enlargement of operationally compacted sensing powder.

FIG. 6 is a cross section showing a completed electrode with sensing composite end surface exposed.

FIG. 7 shows the positive peak of a cyclic voltammogram.

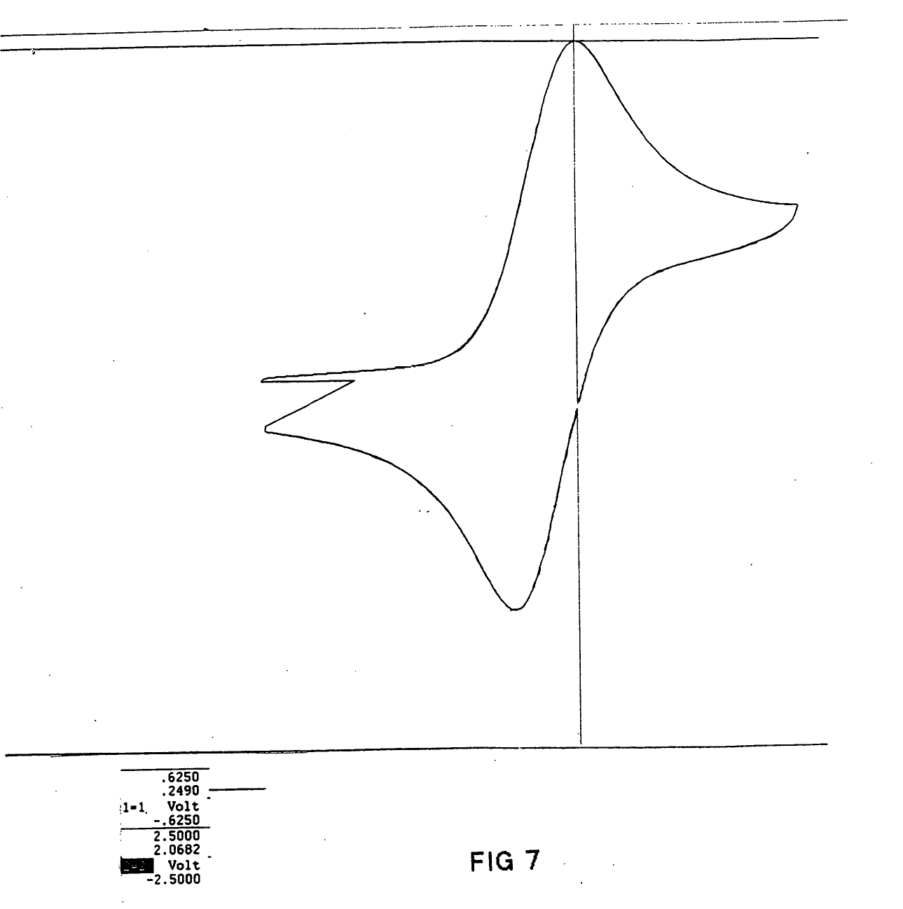

FIG. 8 shows the negative peak of a cyclic voltammogram.

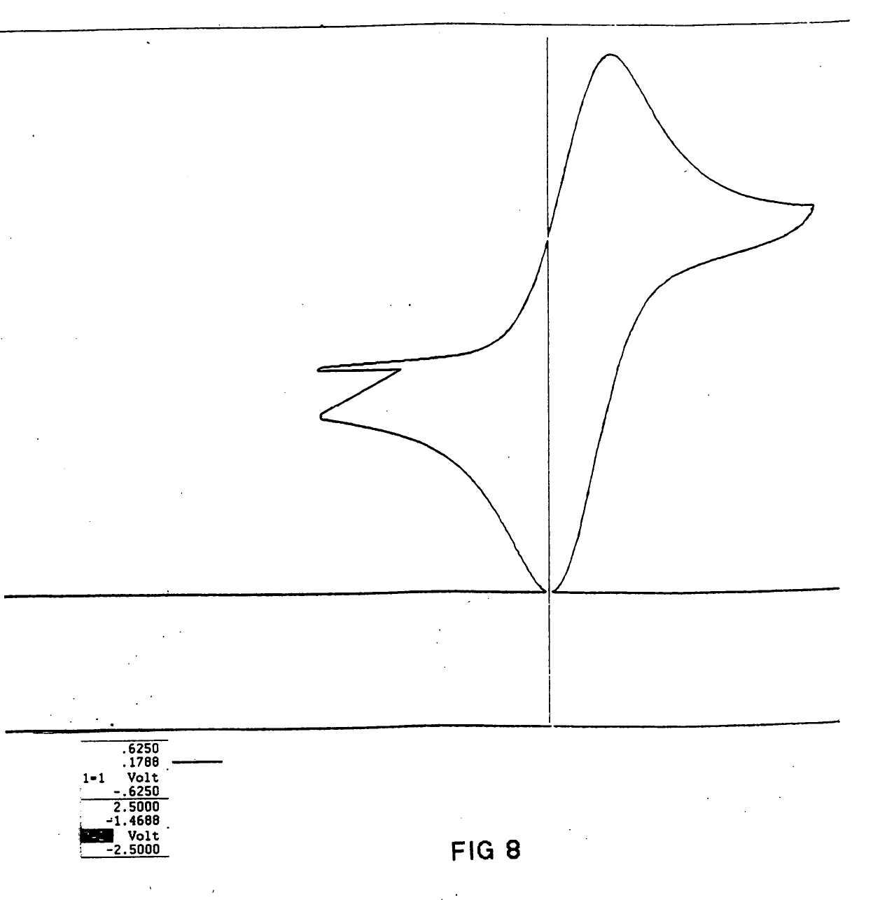

### REFERENCE NUMERALS IN DRAWINGS

10 Hollow Threaded Plastic Cylinder

20 Penetrating Compacting Contact Screw

30 Compacted Composite Sensing Element

40 Penetration Displaced Sensing Element Material

50 Gap

60 Initial Consolidation Pin

70 Sensing Powder

75 Curable Bonding Medium

80 Filling Resin

90 Finished Electrode Surface

### DESCRIPTION OF THE PREFERRED EMBODIMENT

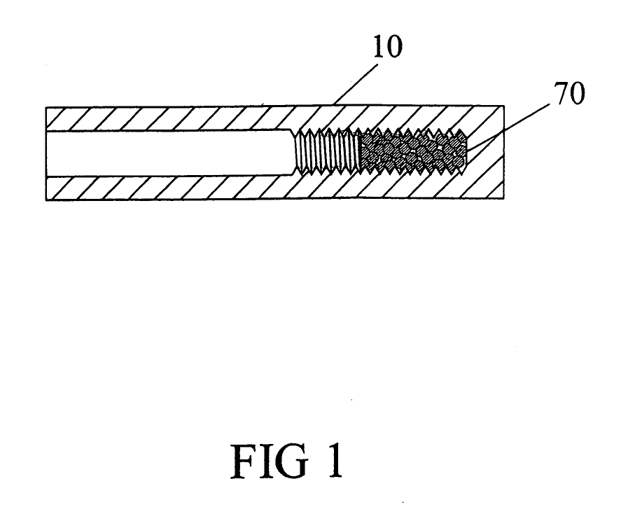

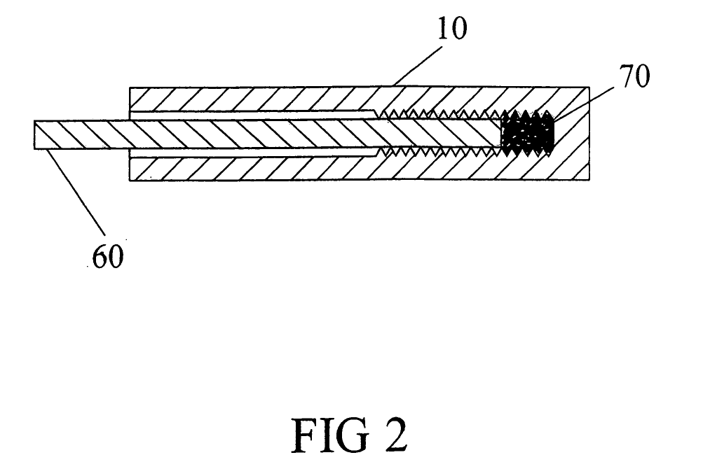

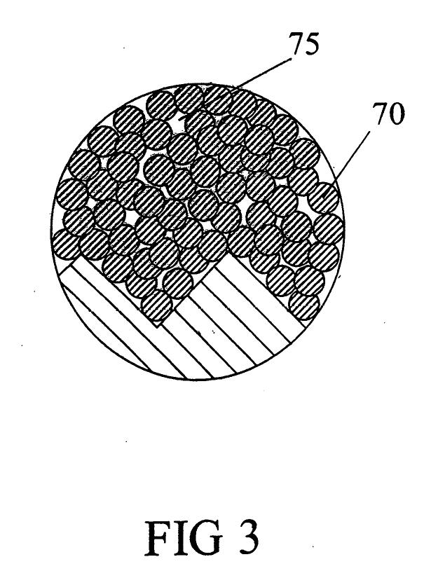

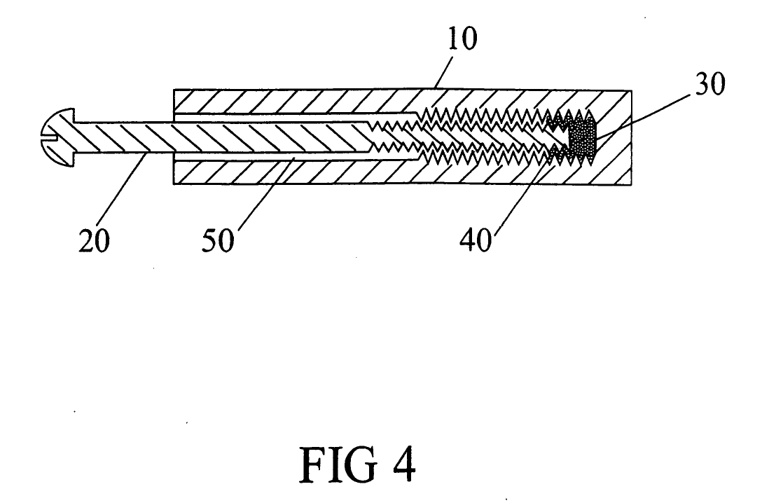

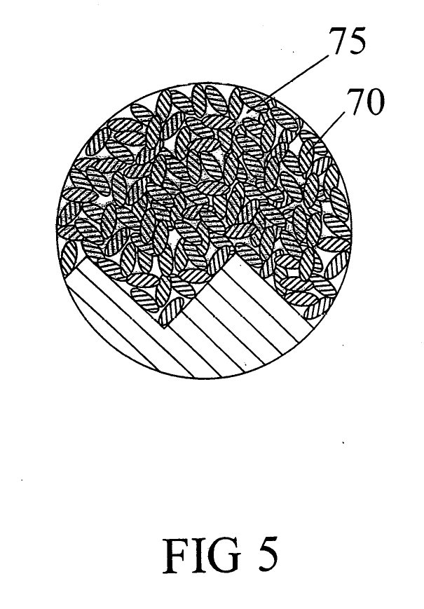

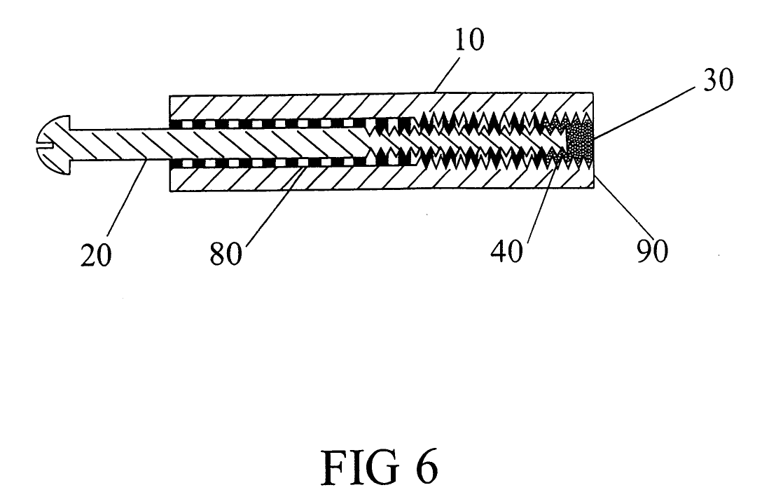

FIG. 1 shows a cross section of Hollow Threaded Plastic Cylinder 10, having received a quantity of Sensing Powder 70 placed at its closed end. FIG. 2 shows Initial Consolidation Pin 60 pushed into contact with Sensing Powder 70 and force applied to achieve initial consolidation. Pin 60 is removed and Curable Bonding Resin 75 is added. FIG. 3 is an enlarged conceptual depiction with Bonding Medium 75 infused by capillary action throughout the interstitial spaces between particles of the initially consolidated Sensing Powder 70, creating a composite material mass. After infusion Penetrating Compacting Contact Screw 20 is installed. FIG. 4 shows Screw 20 driven onto and into the composite developing the final operational density of Compacted Composite Sensing Element 30, while producing Penetration Displaced Sensing Element Material 40 encasing the tip of Screw 20. FIG. 5 is an enlarged conceptual depiction of final operational density of Sensing Element 30. As shown in cross section FIG. 6, the electrode construction is complete when Gap 50 is filled, Filling Resin 80 is cured, and Finished Electrode Surface 90 exposes the outer surface of Sensing Element 30.

Conceptual depictions FIGS. 3 and 5 are far removed from actual material shapes and configurations, and only meant to convey ideas of the invention. In actuality the powder particles are irregular in shape and they and interstitial spaces can only be visualized with technology such as transmission electron microscopy (TEM) or scanning electron microscopy (SEM), vastly magnifying the material image. Magnifications of one thousand times to fifty thousand times are useful for structures of the present invention.

What is claimed is:

1) A process for forming a composite sensing electrode comprising the steps of:
a. placing a sensing powder into a threaded closed end cylinder, and
b. partially consolidating said sensing powder against the closed end retaining interstitial porosity, and
c. adding a curable bonding resin, and
d. allowing for capillary infusion of the bonding resin throughout the interstitial porosity, and
e. driving a compacting conductor screw tip onto and into the partially consolidated and infused powder further compacting and electrically contacting it, and
f. curing the bonding resin, and
g. exposing the end surface of the composite.

2) The process of claim 1 wherein a torque driver controls the driving force applied to the screw tip.

3) A sensing electrode comprising:
a. a hollow threaded cylinder, and
b. a cured composite of bonding resin and sensing powder compacted at one end, and
c. a conductor screw tip partially driven into and conductively encased by the composite.

4) The sensing electrode of claim 3 wherein the composite consists of cured bonding resin filling interstitial spaces between sensing powder particles.

5) The sensing electrode of claim 3 wherein the encased conductor screw tip is in electrical contact with the sensing powder particles.

6) The sensing electrode of claim 3 wherein hollow threaded cylinder material is polymeric.

7) The sensing electrode of claim 3 wherein the sensing powder is carbon.
